(19) United States
(12) Patent Application Publication
(10) Pub. No.: US 2012/0057224 A1
(43) Pub. Date: Mar. 8, 2012

(54) METHOD OF MAINTAINING A COLOR OF A CURED FILM FORMED FROM A COATING COMPOSITION

(76) Inventors: David Story, Waterville, OH (US); Mark Slawikowski, Brighton, MI (US)

(21) Appl. No.: 12/680,831

(22) PCT Filed: Sep. 30, 2008
(86) PCT No.: PCT/US08/11291

§ 371 Date: Nov. 22, 2011

Related U.S. Application Data
(60) Provisional application No. 60/977,743, filed on Oct. 5, 2007.

(51) Int. Cl. G02B 5/26; G02B 5/08; B05D 1/28; B05D 1/02; B05D 5/06; B05D 3/02

(52) U.S. Cl. 359/359; 427/8

(57) ABSTRACT

A method of maintaining a color of a cured film formed from a coating composition on a metal substrate relative to a standard comprises the steps of providing a resin, providing a pigment, combining the pigment and the resin to form the coating composition, applying the coating composition to the metal substrate, curing the coating composition to form the cured film having a color defined by an L value, an a value, and a b value, and maintaining the color relative to the standard having an Ls value, an as value, and a bs value whereby the L value, the a value, and the b value each change less than 20% respectively as compared to the L5 value, the as value, and the bs value of the standard. The cured film has a solar reflectance of greater than or equal to 0.75 in the wavelength from 250-2,500 nm.

### RELATED APPLICATIONS

This application claims priority to and all advantages of U.S. Provisional Patent Application No. 60/977,743, which was filed on Oct. 5, 2007.

### BACKGROUND OF THE INVENTION

1. Field of the Invention

The subject invention generally relates to a method of maintaining a color of a cured film formed from a coating composition on a metal substrate. More specifically, the subject invention relates to a cured film having a solar reflectance.

2. Description of the Related Art

Coating systems typically include coating compositions that are formulated to provide metal substrates with certain functional and aesthetic qualities, such as color, appearance, and protection. Such coating compositions are also typically formulated according to whether the coating compositions are applied to the metal substrate before or after the metal substrate is formed into an end use. For example, automotive coating compositions may be applied to steel that has already been formed into vehicle bodies to impart color, sheen, and corrosion protection. In contrast, industrial, e.g., coil, coating compositions may pre-coat steel coils to impart color, solar reflectance, and weatherability to steel that will later be formed into, for example, commercial and residential roofs.

Existing coating systems typically include coating compositions that cure on the metal substrate to form a cured film. Many applications, such as materials for commercial and residential construction and vehicle bodies, require cured films having solar reflectance. Solar reflectance of a cured film is a measure of a ratio of reflected solar radiation to incident flux, i.e., the ratio of reflected solar radiation to incoming solar radiation. Solar reflectance ranges from 0 to 1 and is often expressed as a percentage from 0% to 100%, with a higher number indicating a higher solar reflectance. A cured film with a relatively high solar reflectance will reflect more solar radiation as compared to a cured film with a relatively low solar reflectance. Moreover, each additional percentage point of solar reflectance typically reduces metal substrate temperature by one degree.

Federal and State governments classify roofs as Energy Star or Cool Roof Rating Council (CRRC) compliant if the cured film has a solar reflectance of 0.75 or higher. Technology to achieve “cool roof” performance that enables a reduction in air temperature and energy consumption, as well as accompanying costs, is available, but only for white and other light colors. Therefore, existing metal roofing offers limited design options for “cool roof” performance. As such, it would be advantageous to also achieve “cool roof” performance for dark colors.

It is currently known in the art to add pigments to coating compositions to adjust functional and aesthetic properties. However, the addition of pigments to coating compositions may result in a color change of cured films formed from the coating compositions, especially for dark colors. As a result, many existing cured films have acceptable color readings, but are not compliant for solar reflectance, i.e. the cured films may match a color standard but have a solar reflectance under a proscribed Federal or state limit. It is typically difficult to alter the solar reflectance in existing cured films without significantly changing the color of the cured film. As such, it would be advantageous to provide cured films that are compliant for solar reflectance without significantly changing the color of the cured films.

Due to the deficiencies of the existing art, there is a need for a coating system that does not suffer from the aforementioned inadequacies.

### SUMMARY OF THE INVENTION AND ADVANTAGES

The present invention provides a method of maintaining a color of a cured film formed from a coating composition on a metal substrate relative to a standard. The method comprises the steps of providing a resin, providing a pigment, and combining the pigment and the resin to form the coating composition. The method also comprises the steps of applying the coating composition to the metal substrate and curing the coating composition on the metal substrate to form the cured film. The cured film has a color defined by an L value, an a value, and a b value as measured by a spectrophotometer according to a Hunter L, a, b color scale. The method also comprises the step of maintaining the color of the cured film relative to the standard having an Lₛ value, an aₛ value, and a bₛ value whereby the L value, the a value, and the b value of the cured film each change less than 20% respectively as compared to the Lₛ value, the aₛ value, and the bₛ value of the standard. The cured film formed from the coating composition has a solar reflectance of greater than or equal to 0.75 in the wavelength from 250 nm to 2,500 nm as measured in accordance with ASTM E903-96 and ASTM C 1549-04. The present invention also provides a coating system comprising a metal substrate and the cured film disposed on the metal substrate.

The method and coating system of the present invention advantageously achieve “cool roof” performance for cured films, including cured films having dark colors. In particular, the method and coating system provide cured films having excellent solar reflectance in a range of color choices. The method and coating system optimize solar reflectance of cured films while maintaining the color of the cured film. Finally, the method and coating system enable energy cost savings, since interior spaces of buildings and vehicles are kept cool, optimize roof life expectancy based on minimized roof expansion and contraction, and allow potential qualification for monetary incentives that are offered for cured films having excellent solar reflectance.

### BRIEF DESCRIPTION OF THE DRAWING

Other advantages of the present invention will be readily appreciated, as the present invention becomes better understood by reference to the following detailed description when considered in connection with the accompanying drawing wherein:

FIG. 1 is a cross-sectional view of a coating system.

### DETAILED DESCRIPTION OF THE INVENTION

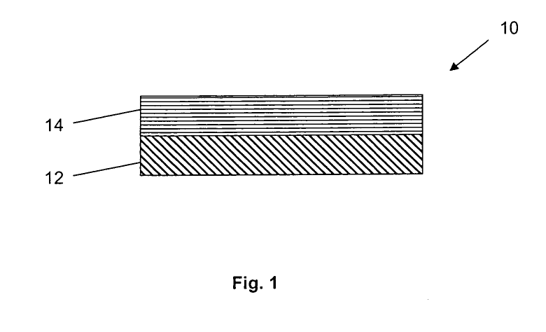

Referring to FIG. 1, the present invention provides a coating system 10 comprising a metal substrate 12 and a cured film 14 having a color disposed on the metal substrate 12. The present invention also provides a method of maintaining the color of the cured film 14 formed from a coating composition on the metal substrate 12 relative to a standard. The coating composition is typically applied to the metal substrate 12 before the metal substrate 12 is formed into an end use, i.e. the metal substrate 12 is typically pre-coated before being formed into the end use. Typical applications for the coating composition include the commercial and residential building, heating, ventilation and air conditioning, appliance, tractor-trailer equipment, and consumer electronics industries. In particular, in the commercial and residential building industries, the method may be used to provide color and solar reflectance to cured films formed from industrial coating compositions for roofs, windows, doors, and gutters. However, it is to be appreciated that the method and coating system 10 of the present invention can have applications beyond industrial coating applications, such as automotive coating applications.

The method comprises the step of providing a resin. It is to be appreciated that the resin is typically provided separately from any other components of the coating composition, as set forth in more detail below. The resin typically encapsulates components, such as pigments and micas, in the coating composition and binds such components to the metal substrate 12. It is also to be appreciated that the step of providing the resin may include the step of providing a resin, providing at least one resin, providing multiple resins, and/or providing a combination of resins. It is also to be appreciated that the resin may be cross-linked or non-cross-linked, as set forth in more detail below.

In one embodiment, the resin is further defined as a siliconized polyester resin. The siliconized polyester resin is typically selected for applications requiring cured films having temperature resistance and weatherability since silicone typically mitigates deterioration of cured films caused by temperature fluctuations.

Although the siliconized polyester resin may be prepared by any method known in the art, the siliconized polyester resin is typically prepared by integrating silicone into a polyester resin having a backbone. That is, silicone is typically incorporated into the backbone of the polyester resin via a condensation reaction to form the siliconized polyester resin. Typically, the siliconized polyester resin is prepared by reacting the polyester resin with any suitable silicone having a glass transition temperature, Tg, greater than 30° C. The silicone is typically present in the siliconized polyester resin in an amount of from 1 to 75, more typically 10 to 40, and most typically 20 to 35 parts by weight based on the total weight of the siliconized polyester resin. When the silicone is present in an amount less than 1 part by weight, the resin may not mitigate deterioration of the cured film 14 caused by temperature fluctuations. Similarly, when the silicone is present in an amount greater than 75 parts by weight, excess silicone is typically not easily integrated into the backbone of the polyester resin.

Suitable polyester resins for providing the backbone of the siliconized polyester resin typically have a number average molecular mass, Mₙ, of from 1,000 to 20,000, more typically from 1,500 to 4,500, and most typically from 2,000 to 4,000 g/mol. The polyester resin typically has a weight average molecular mass, K_{w}, of from 2,000 to 40,000, more typically from 5,000 to 20,000, and most typically from 5,000 to 10,000 g/mol. Furthermore, the polyester resin typically has a hydroxyl number of from 5 to 150, more typically from 15 to 105 mg KOH/g, and an acid value of from 1 to 30, more typically from 3 to 15 mg KOH/g.

The polyester resin is typically produced by a condensation reaction between polyols, predominantly diols and triols, and polycarboxylic acids or corresponding anhydrides thereof. The polyols typically contain from about 2 to 20 carbon atoms. Aliphatic polyols, particularly aliphatic diols or triols containing from 2 to 10 carbon atoms, are typical. Specific examples of suitable polyols include, but are not limited to, ethylene glycol, 1,2-propanediol, 1,3-propanediol, 1,3-propylene glycol, 1,4-butanediol, 1,4-butylene glycol, 1,5-pentanediol, glycerol, 1,2,3-butanetriol, 1,6-hexanediol, neopentyl glycol, diethylene glycol, 2-methyl-1,3-propanediol, dipropylene glycol, 2-methyl-1,3-propanediol, trimethylolethane, trimethylolpropane, triethyleneglycol, 2,2,4-trimethylpentane-1,3-diol, 2,2-dimethyl-3-hydroxypropyl2,2-dimethyl-3-hydroxypropionate, 1,4-cyclohexanedimethanol, 1,4-cyclohexanediol, pentaerythritol, and dipentaerythritol. Combinations of two or more polyols may also be used. Triols, such as trimethylolpropane, are typically used at low levels to provide branching to the polyester resin if desired.

The polycarboxylic acids typically used in the condensation reaction to produce the polyester resin include, but are not limited to, adipic, methyladipic, malonic, sebacic, suberic, glutaric, fumaric, itaconic, malic, diglycolic, the 1,3- and 1,4-cyclohexanedicarboxylic acids, pimelic, azelaic, 1,12-dodecanedioic, maleic acid, maleic anhydride, succinic acid, succinic anhydride, isophthalic acid, terephthalic acid, and methylsuccinic and tetrapropenyl succinic acids and their anhydrides, and tetrahydrophthalic anhydride. Combinations of two or more polycarboxylic acids can be used. Examples of aromatic polycarboxylic acids which may be used in place of or in combination with the aliphatic or cycloaliphatic acids include phthalic acids and phthalic anhydride, benzophenone dicarboxylic acid, diphenic acid, 4,4-dicarboxydiphenyl ether, and trimellitic acid.

A siliconized polyester resin that is suitable for purposes of the present invention typically has a number average molecular mass, Mₙ, of from 500 to 9,000, more typically from 1,500 to 4,500, and most typically from 2,000 to 4,000 g/mol. The siliconized polyester resin typically has a weight average molecular mass, M_{w}, of from 10,000 to 50,000 more typically from 12,000 to 40,000, and most typically from 15,000 to 35,000 g/mol. The siliconized polyester resin is typically aliphatic with hydroxyl functionality and typically has a hydroxyl number of from 5 to 1,000, more typically from 15 to 60 mg KOH/g, and an acid value of from 1 to 30, more typically from 3 to 15 mg KOH/g.

In the embodiment where the resin is a siliconized polyester resin, the coating composition typically further comprises a cross-linking agent that is reactive with the siliconized polyester resin. The cross-linking agent typically reacts with active hydrogen atoms in the siliconized polyester resin to form the cured film 14.

The cross-linking agent typically comprises a melamine formaldehyde resin. One example of a suitable melamine formaldehyde resin is a fully methylated melamine. The melamine formaldehyde resin may include alkoxymethyl groups of the general formula:

—CH₂OR₁

where R₁ is an alkyl chain having from 1 to 20 carbon atoms. A specific example of a suitable melamine formaldehyde resin for the purposes of this invention is hexamethoxymethyl melamine under the tradename Resimene®, commercially available from Solutia of St. Louis, Mo.

Other cross-linking agents may also be suitable. For example, the cross-linking agent may be other monomeric and polymeric melamine formaldehyde resins, including both partially and fully alkylated melamines, such as other methylated melamines, butylated melamines, and methylated/butylated melamines. The cross-linking agent may also be other aminoplasts including, but not limited to, urea resins such as methylol ureas and alkoxy ureas, e.g. butylated urea formaldehyde resin.

The cross-linking agent is typically present in the coating composition in an amount from 0.5 to 3, more typically from 1 to 2 parts by weight based on 100 parts by weight of the coating composition. When the cross-linking agent is present in an amount of less than 0.5 parts by weight, it is difficult to cure the cured film 14 of the coating composition. Similarly, when the cross-linking agent is present in an amount of greater than 3 parts by weight, the cured film 14 typically loses flexibility and is subject to cracking and peeling on the metal substrate 12.

In another embodiment, the resin is further defined as a polyvinylidene fluoride (PVDF) resin. As set forth below in more detail below, PVDF resins are typically selected for applications requiring excellent cured film strength, gloss, color retention, and weatherability.

Although the PVDF resin may be prepared by any method known in the art, the PVDF resin is typically synthesized from a gaseous vinylidine diflouride monomer via a free radical polymerization process. The PVDF resin typically comprises a polymer chain having alternating —CH₂ and —CF₂ groups, which typically contribute to selective solubility of the PVDF resin. Without intending to be limited by theory, it is believed that selective solubility of the polyvinylidene fluoride resin contributes to excellent weatherability of cured films 14 formed from coating compositions comprising the PVDF resin.

The polyvinylidene fluoride resin typically has a weight average molecular mass, M_{w}, of from 50,000 to 500,000, more typically from 70,000 to 250,000, and more typically from 80,000 to 150,000 g/mol. Suitable PVDF resins are available under the trade name Kynar 500® and are commercially available from Arkema Inc. of Philadelphia, Pa.

It is to be appreciated that other resins not mentioned herein, such as acrylic resins and polyester resins, may also be suitable for purposes of the present invention. Suitable acrylic resins may be prepared by reacting acrylic acid with an alcohol to form a carboxylic ester. The carboxylic ester may combine with itself or monomers to form the acrylic resin, which may be a homopolymer. The acrylic resin typically has a number average molecular mass, Mₙ, of from 2,000 to 50,000, more typically from 3,000 to 35,000, and most typically from 5,000 to 25,000 g/mol. The acrylic resin typically has a weight average molecular mass, M_{w}, of from 5,000 to 100,000, more typically from 8,000 to 80,000, and most typically from 10,000 to 70,000 g/mol. Likewise, suitable polyester resins and methods of preparing polyester resins include any set forth above.

The resin is typically present in the coating composition in an amount of from 30 to 70, more typically 40 to 65, and most typically 55 to 60 parts by weight based on 100 parts by weight of the coating composition. When the resin is present in an amount of less than 30 parts by weight, the resin cannot effectively encapsulate other components such as pigments and micas in the coating composition. Likewise, when the resin is present in an amount of greater than 70 parts by weight, the cured film 14 typically loses flexibility and is subject to peeling and cracking on the metal substrate 12.

In addition to the resin, the coating composition may comprise other components. For example, the coating composition also typically comprises a solvent component. The solvent component typically suspends the resin and other components in the coating composition and evaporates upon cure during formation of the cured film 14. The solvent component is typically present in the coating composition an amount from 25 to 60, more typically from 30 to 50, and most typically from 35 to 45 parts by weight based on 100 parts by weight of the coating composition. When the solvent component is present in an amount of less than 25 parts by weight, the resin is typically not effectively suspended in the coating composition. Similarly, when the solvent component is present in an amount greater than 60 parts by weight, the cured film 14 is often difficult to form or has an unacceptable color since the solvent component often does not thoroughly evaporate. The solvent component is typically organic. Suitable solvent components for the purposes of the present invention include glycols, esters, ether-esters, glycol-esters, ether-alcohols, aliphatic hydrocarbons, aromatic hydrocarbons, phthalate plasticizers, and combinations thereof.

The coating composition also typically includes a catalyst. The catalyst typically promotes curing of the coating composition to form the cured film 14. The catalyst is typically present in the coating composition in an amount of from 0.1 to 5.0 parts by weight based on 100 parts by weight of the coating composition. Suitable catalysts for the purposes of the present invention include p-toluene sulfonic acid, methane sulfonic acid, nonylbenzene sulfonic acid, dinonyl-naphthalene disulfonic acid, dinonylnaphthalene sulfonic acid, dodecylbenzene-sulfonic acid, phenyl acid phosphate, monobutyl maleate, butyl phosphate, monoalkyl and dialkyl acid phosphates, hydroxy phosphate ester, Lewis acids, zinc salts, and tin salts. Catalysts comprising a strong acid may be blocked with an amine.

The coating composition may also include an additive component. The additive component is typically present in the coating composition in an amount of from 1 to 20, more typically from 5 to 15, and most typically from 7 to 12 parts by weight based on 100 parts by weight of the coating composition. Suitable additive components may be selected from the group of flattening or matting agents, waxes, surfactants, fillers, plasticizers, emulsifiers, texturizers, thickeners, adhesion promoters, stabilizers, defoaming agents, wetting additives, colorants, and combinations thereof. Other additive components not specifically recited herein may also be suitable for purposes of the present invention.

The method further comprises the step of providing a pigment. As recited herein, the pigment is distinct from the aforementioned colorants of the additive component. As set forth above, it is to be appreciated that the coating composition may comprise colorants, such as pigments, in addition to the pigment set forth below. That is, the coating composition may comprise colorants, such as pigments, intended for coloration of the coating composition and/or cured film 14. Such colorants are to be distinguished from the pigment set forth below.

The pigment that is provided for the method of the present invention typically comprises a mica particle and a coating disposed on the mica particle. As used herein, the terminology “disposed on” denotes that the coating is in contact with the mica particle and may partially or substantially encapsulate the mica particle. For example, the coating may partially encapsulate the mica particle so that portions of the mica particle are uncovered. Or, the coating may substantially encapsulate the mica particle, i.e., cover greater than 95% of the mica particle. The coating may be disposed on the mica to form the interference pigment by numerous methods, such as by precipitation.

Suitable mica particles include any known in the art and can be described as generally comprising elements such as K, Na, Ca, Ba, Rb, Cs, Al, Mg, Fe, Mn, Cr, Ti, Li, Si, and/or Fe3+. The mica particle may be classified as, for example, di-octahedral or tri-octahedral. The mica may also be classified as a common mica or a brittle mica.

The coating disposed on the mica particle typically comprises at least two layers. That is, the coating may comprise two, or more than two, layers. Each layer may be the same as or different from another layer. For example, in an embodiment comprising two of the same layers, each layer is typically applied separately. For the present invention, at least one layer typically comprises an inorganic oxide. Further, the inorganic oxide is typically selected from the group of metal oxides, silicon oxides, and combinations thereof. The metal oxides may include any metal oxide known in the art. Suitable metal oxides include, but are not limited to, titanium dioxide, tin oxide, zirconium oxide, and combinations thereof. The silicon oxides may include any silicon oxide known in the art. For example, in one embodiment, the silicon oxide is further defined as silicon dioxide. In particular, the inorganic oxide is typically titanium dioxide, silicon dioxide, tin oxide, or zirconium oxide. In one embodiment, the coating comprises titanium dioxide, silicon dioxide, tin oxide, and zirconium oxide.

For ease of addition to the coating composition, the pigment typically has a particle size of from 10 to 60 μm as measured in accordance with ISO 1524. It is to be appreciated that the particle size of the pigment typically refers to the length of the pigment because the pigment, like the mica included therein, typically has a platelet shape, i.e., the pigment is not spherical. Further, also for ease of addition to the coating composition, the pigment typically has a density at 20° C. of from 2.6 to 2.8 g/cm³ and a pH value at 20° C. of from 4 to 8 for a slurry of 100 g of the pigment per liter of water. It is believed that the particle size and platelet shape of the pigment allows the pigment to more closely resemble a powder than a conventional mica, which contributes to the excellent solar reflectance, emissivity, and solar reflectance index of the cured films 14, while maintaining the color of the cured films 14 prepared by the method of the present invention, as set forth in more detail below. In particular, conventional micas typically tend to form a cured film having a “sparkle” and an accompanying color change.

The pigment is typically further defined as an interference pigment. As used herein, the terminology “interference pigment” refers to pigments that bend and reflect light within the visible spectrum at boundaries between the mica particle and the coating disposed on the mica particle. For example, the coating typically reflects light twice, once at a boundary between the mica particle and the coating, and once at an exposed surface of the coating. A delay between a first reflection and a second reflection phase-shifts the light. The phase-shift cancels some wavelengths of light and reinforces other wavelengths of light.

The pigment is typically colorless. For the purposes of the subject invention, the terminology “colorless” is defined to mean that the pigment does not have a color. The terminology “colorless” is further defined to mean that the absorption curve for the pigment is devoid of absorption peaks in the 400-700 nm range and does not present a tint or hue in reflected or transmitted light when viewed under sunlight conditions. The pigment is also typically translucent. For the purposes of the subject invention, the terminology “translucent” is defined to mean that light passes through the pigment diffusely. Without intending to be limited by theory, it is believed that the colorless translucence of the pigment contributes to improved solar reflectance of the cured film 14 formed from the coating composition while maintaining the color of the cured film 14.

The pigment typically has a transmission of at least 50% of electromagnetic radiation in the wavelength from 400 nm to 700 nm and at least 40% of electromagnetic radiation in the wavelength from 780 nm to 2,500 nm. More specifically, the pigment is typically a translucent, colorless multi-layer pigment with a highest transmission value for wavelengths of photosynthetic active light. Photosynthetic active light is defined as light with wavelengths of from 400 to 700 nm that plants need for photosynthesis. The pigment typically has a positive light red/dark red ratio of 1.4:1. Without intending to be limited by theory, it is believed that the high transmission value for wavelengths of photosynthetic active light and the positive light red/dark ratio contributes to improved solar reflectance of the cured film 14 formed from the coating composition. A suitable pigment for the purposes of this invention includes the Solarflair™ 9870 pigment commercially available from Merck KGaA of Darmstadt, Germany.

The method also comprises the step of combining the pigment and the resin to form the coating composition. The pigment and the resin may be combined by any means known in the art, and order of addition is unimportant. For example, the pigment may be added directly to the resin of the coating composition under agitation. The pigment is typically present in the coating composition an amount of from 0.25 to 5, more typically from 0.5 to 3, and most typically from 0.75 to 2.75 parts by weight based on 100 parts by weight of the coating composition. The pigment is typically present in the coating composition in the aforementioned range to impart excellent solar reflectance, e.g., a solar reflectance of greater than or equal to 0.75 in the wavelength from 250 nm to 2,500 nm as measured in accordance with ASTM E903-96 and ASTM C1549-04, to cured films 14 formed from the coating composition. Moreover, the pigment is typically present in the coating composition in the aforementioned range to maintain the color of the cured film 14 relative to the standard while providing excellent solar reflectance, as set forth in more detail below.

The method also comprises the step of applying the coating composition to the metal substrate 12. The metal substrate 12 may be formed from any metal known in the art, but is typically formed from steel or aluminum. In one embodiment, the metal substrate 12 is a roof of a building.

The coating composition may be applied to the metal substrate 12 by any means known in the art. Without intending to be limiting, the coating composition is typically applied to the metal substrate 12 using at least one transfer device, e.g., a roller or a sprayer.

For example, in one embodiment, the step of applying the coating composition is further defined as providing at least one roller and transferring the coating composition from the at least one roller to the metal substrate 12. For instance, a first roller typically transfers the coating composition from an open holding receptacle to a second roller, and the second roller typically transfers the coating composition to the metal substrate 12. The coating composition is typically applied at an ambient temperature of from 0 to 100° C. and at a peak metal temperature of from 176 to 290° C. In this embodiment, the coating composition is typically further defined as an industrial coating composition. The industrial coating composition typically pre-coats the metal substrate 12 before the metal substrate 12 is formed into an end use. For example, the industrial coating composition is transferred from the at least one roller to the metal substrate 12 before the metal substrate 12 is formed into, for example, a roof, a building panel, or a gutter. In this embodiment, the cured film 14 typically has a thickness of from 0.5 to 0.9 mil.

In another embodiment, the step of applying the coating composition is further defined as spraying the coating composition onto the metal substrate 12. For example, the sprayer is typically connected via piping to a receptacle which holds the coating composition. The coating composition is typically fed through the piping to the sprayer and sprayed onto the metal substrate 12. The coating composition is typically applied at an ambient temperature of from 0 to 100° C. and at a peak metal temperature of from 176 to 290° C. In this embodiment, the coating composition is typically further defined as an automotive coating composition. The automotive coating composition is typically applied to the metal substrate 12 after the metal substrate 12 has been formed into an end use. For example, the automotive coating composition is sprayed onto the metal substrate 12 after the metal substrate 12 has been formed into a vehicle body. In this embodiment, the cured film 14 typically has a thickness of from 0.5 to 4 mil. It is to be appreciated that other methods of applying the coating composition to the metal substrate 12 may also be employed. For example, the coating composition may be applied by hand or via dipping.

The method includes the step of curing the coating composition on the metal substrate 12 to form the cured film 14 having a color defined by an L value, an a value, and a b value as measured by a spectrophotometer according to a Hunter L, a, b color scale. As known in the art, the Hunter L, a, b color scale is a method for measuring the color of an object. The L value of the Hunter L, a, b color scale is associated with a light/dark scale, wherein an L value of 100 represents light, e.g., a perfect reflecting diffuser, and an L value of 0 represents dark, e.g., black. Similarly, the a value of the Hunter L, a, b color scale is associated with a red/green scale and the b value is associated with a yellow/blue scale. The a value and the b value have no numerical limits. A positive a value represents red and a negative a value represents green; a positive b value represents yellow and a negative b value represents blue. A suitable spectrophotometer for measuring the color of the cured film 14 is, for example, a 45°/0° UV/vis spectrophotometer. In a typical embodiment, the cured film 14 has a dark color. That is, the color of the cured film 14 is defined by an L value of less than or equal to 75, a negative a value, and a negative b value as measured by a spectrophotometer according to the Hunter L, a, b color scale.

The coating composition is typically cured on the metal substrate 12 in an oven. However, it is to be appreciated that although the step of curing the coating composition typically occurs in an oven, the coating composition may also be cured using an open heat source.

In the embodiment where the coating composition is applied to the metal substrate 12 before the metal substrate 12 is formed into an end use, e.g., the embodiment including an industrial coating composition applied to the metal substrate 12 via at least one roller, the step of curing the coating composition is typically conducted at a temperature of from 700° F. to 900° F. for a period of from 20 to 100 seconds. More specifically, the coating composition is typically cured on the metal substrate 12 in an oven at an oven temperature of from 700° F. to 900° F. for a period of from 20 to 100 seconds so that the metal substrate 12 has a peak metal temperature (PMT) of from 435° F. to 500° F. while in residence in the oven.

In the embodiment where the coating composition is applied to the metal substrate 12 after the metal substrate 12 is formed into an end use, e.g., the embodiment including an automotive coating composition applied to the metal substrate 12 via a sprayer, the step of curing the coating composition is typically conducted at a temperature of from 75° F. to 450° F. for a period of from 60 to 1,200 seconds. More specifically, the coating composition is typically cured on the metal substrate 12 in an oven at an oven temperature of from 300° F. to 350° F. for a period of from 900 to 1,200 seconds so that the metal substrate 12 has a peak metal temperature (PMT) of from 300° F. to 350° F. while in residence in the oven.

The method typically further comprises the step of cooling the cured film 14 formed from the coating composition to about an ambient temperature. The cured film 14 on the metal substrate 12 is typically sprayed with a coolant, such as water, to effect the cooling. The step of cooling prepares the cured film 14 and the metal substrate 12 for any further processing. For example, in an embodiment including the industrial coating composition, the metal substrate 12 having the cured film 14 disposed on the metal substrate 12 is typically formed into, for example, panels for a roof of a building. Similarly, in an embodiment including the automotive coating composition, other vehicle components and systems, for example, trim components, electronic systems, and a powertrain, are coupled with the metal substrate 12 having the cured film 14 disposed on the metal substrate 12 to form a vehicle.

The method also comprises the step of maintaining the color of the cured film 14 relative to the standard having an Lₛ value, an aₛ value, and a bₛ value whereby the L value, the a value, and the b value of the cured film 14 each change less than 20% respectively as compared to the Lₛ value, the aₛ value, and the bₛ value of the standard. Stated differently, even with the combination of the pigment and the resin to form the coating composition, the color of the cured film 14 formed from the coating composition is maintained relative to the standard. The Lₛ value, the aₛ value, and the bₛ value of the standard represent the L value, the a value, and the b value of a cured film formed from a standard coating composition prior to the addition of the pigment. When the pigment and the resin are combined, the color of the resulting cured film 14 formed from the coating composition matches the color of the standard, i.e., the color of the cured film formed from the standard coating composition prior to the addition of the pigment. That is, the L value, the a value, and the b value of the cured film 14 formed from the coating composition each change less than 20%, typically less than 10% respectively, as compared to the Lₛ value, the aₛ value, and the bₛ value of the standard. More specifically, even for dark colors, the color of the cured film 14 formed from the coating composition, represented by the L value, the a value, and the b value, does not vary substantially from the standard, i.e., the color of the cured film formed from the standard coating composition. The terminology “does not vary substantially” refers to the fact that the L value, the a value, and the b value typically each change less than 20%, more typically less than 15%, and most typically less than 10%, respectively, as compared to the Lₛ value, the aₛ value, and the bₛ value. As such, the pigment set forth above, does not substantially change the color of the cured film 14 as compared to the standard. Without intending to be limited by theory, it is believed that the colorless translucence, the high transmission value for wavelengths of photosynthetic active light, and the positive light red/dark ratio of the pigment contribute to maintaining the color of the cured film 14.

The cured film 14 formed from the coating composition has a solar reflectance of greater than or equal to 0.75 in the wavelength from 250 nm to 2,500 nm as measured in accordance with ASTM E903-96 and ASTM C1549-04. Cured films having a relatively high solar reflectance will reflect more solar radiation as compared to cured films having a relatively low solar reflectance. Moreover, each additional percentage point of solar reflectance typically reduces metal substrate temperature by one degree. Therefore, the cured film 14 is typically useful for applications requiring minimal metal substrate temperatures, e.g., metal substrates that will be formed into commercial and residential roofs. In particular, the cured film 14 is typically useful for applications requiring “cool roofs”, e.g., roofs that effectively reflect solar energy away from the roof.

The cured film 14 formed from the coating composition also typically has an emissivity of greater than or equal to 0.75 in the wavelength from 250 nm to 2,500 nm as measured in accordance with ASTM E408-71 and ASTM C1371-04a. Emissivity is generally defined as an ability of a surface to emit radiant energy compared to that of a black body at the same temperature having the same area, i.e., a measure of the ability of the surface to radiate absorbed energy. Emissivity is generally expressed as a dimensionless value from 0 to 1. A dull, black surface has an emissivity closer to 1. In contrast, a reflective material has an emissivity closer to 0, Since the cured film 14 formed from the coating composition comprising the pigment typically has an emissivity greater than or equal to 0.75, the cured film 14 is typically useful for applications requiring surfaces that can emit infrared energy, e.g., metal substrates that will be formed into commercial and residential roofs. Further, the cured film 14 formed from the coating composition comprising the pigment typically does not radiate absorbed energy as readily as compared to the cured film formed from the standard coating composition prior to the addition of the pigment, i.e., the standard coating composition free from the pigment. Therefore, the cured film 14 formed from the coating composition comprising the pigment is typically useful for commercial and residential roofing applications in areas located in urban heat islands, i.e., a metropolitan area that is significantly warmer than surrounding rural areas.

Further, the cured film 14 formed from the coating composition typically has a solar reflectance index (SRI) of greater than 78 as determined in accordance with ASTM 1980-01. As defined by ASTM 1980-01, solar reflectance index is the relative steady-state surface temperature of a surface with respect to standard white (SRI=100) and standard black (SRI=0) under standard solar and ambient conditions. For equivalent conditions, the steady-state surface temperature of dark surfaces having low solar reflectance is higher than the steady-state surface temperature of light-colored surfaces having high solar reflectance. Also, surfaces with low thermal emissivity have higher steady-state surface temperatures than surfaces with high thermal emissivity. Therefore, solar reflectance index for a surface combines reflectance and emissivity to measure the overall ability of the surface to reject solar heat. Surfaces having a solar reflectance index closer to 100 have a lower steady-state surface temperature than surfaces having a solar reflective index closer to 0. Since the cured film 14 formed from the coating composition comprising the pigment typically has a solar reflectance index greater than 78, the cured film 14 is typically useful for applications requiring lower steady-state surface temperatures, e.g., metal substrates that will be formed into commercial and residential roofs or metal substrates formed into vehicle bodies. Therefore, the cured film 14 formed from the coating composition comprising the pigment is also typically useful for commercial and residential roofing applications in areas located in urban heat islands, and for vehicle bodies operated in climates with average daily temperatures above 60° F.

Without intending to be limited by theory, it is believed that the colorless translucence, the high transmission value for wavelengths of photosynthetic active light, and the positive light red/dark ratio of the pigment contribute to the excellent solar reflectance value, emissivity, and solar reflectance index of the cured film 14. Although it is not understood why the cured film 14 of the coating composition comprising the pigment has a solar reflectance of greater than or equal to 0.75 in the wavelength from 250 nm to 2,500 nm and an L value, an a value, and a b value that typically each respectively change less than 20% as compared to the Lₛ value, the aₛ value, and the bₛ value of the standard, it is believed that the color of the cured film 14 is maintained relative to the standard because of the pigment present in the coating composition. In particular, it is theorized that the coating of the pigment typically reflects light twice, once at the boundary between the mica particle and the coating, and once at the exposed surface of the coating. A delay between the first reflection and the second reflection phase shifts the light and cancels some wavelengths of light and reinforces other wavelengths of light.

The excellent solar reflectance, emissivity, and solar reflectance index of the cured film 14 while maintaining the color of the cured film 14 is unexpected since the coating composition comprises the pigment, which comprises a mica particle. Generally, when a conventional mica particle and a resin are combined to form a coating composition, the mica produces a “sparkle” effect and accompanying color change in cured films. Unexpectedly, the pigment of the method of the present invention contributes to cured films 14 having excellent solar reflectance, emissivity, and solar reflectance index, and a color maintained relative to the standard.

Therefore, the method of the present invention advantageously achieves “cool roof” performance for cured films 14, including cured films 14 having dark colors. In particular, the method provides cured films 14 having excellent solar reflectance in a range of color choices. The method optimizes solar reflectance of cured films 14 while maintaining the color of the cured film 14. Finally, since each additional percentage point of solar reflectance reduces metal substrate temperature by one degree, the method of the present invention also optimizes energy consumption and costs. In particular, the method enables energy cost savings, since interior spaces of buildings and vehicles are kept cool, optimizes roof life expectancy based on minimized roof expansion and contraction, and allows potential qualification for monetary incentives that are offered for cured films 14 having excellent solar reflectance.

The present invention also provides the coating system 10. The coating system 10 comprises the metal substrate 12 and the cured film 14 formed from the coating composition disposed on the metal substrate 12. In one embodiment, the metal substrate 12 is a roof of a building. In another embodiment, the metal substrate 12 is a vehicle body. However, it is to be appreciated that the coating system 10 may include other metal substrate applications, such as wall panels, appliances, gutters, aircrafts, and marine vessels.

### EXAMPLES

The following examples are merely intended to illustrate the invention and are not to be viewed in any way as limiting to the scope of the invention.

Coating compositions, Examples 1-2, are prepared by conventional loading and mixing procedures in accordance with the method of the present invention. The coating compositions are formed by a batch blending process where a resin and a pigment are combined under agitation to form the coating compositions.

Reference coating compositions, Reference Examples 3-4, are also prepared by conventional loading and mixing procedures. The reference coating compositions are formed by a batch blending process where components of the reference coating composition are combined under agitation. Notably, the pigment and the resins of the reference coating compositions are not combined to form the reference coating compositions. Rather, the reference coating compositions are free of the pigment.

The specific amounts of each component of the coating compositions are indicated in Table 1, wherein all amounts are in parts by weight based on 100 parts of the coating composition.

TABLE 1

| | Ex. 1 | Ex. 2 | Ref. Ex. 3 | Ref. Ex. 4 |
|---|---|---|---|---|
| Resin A | 5.61 | — | 5.68 | — |
| Cross-linking agent B | 3.06 | — | 3.10 | — |
| Solvent C | 8.47 | — | 8.59 | — |
| Base D | 81.46 | 6.05 | 82.63 | 6.21 |
| Varnish E | — | 69.05 | — | 70.95 |
| Additive F | — | 1.96 | — | 2.01 |
| Solvent G | — | 4.73 | — | 4.86 |
| Isocyanate H | — | 3.35 | — | 3.45 |
| Additive J | — | 2.18 | — | 2.24 |
| UV Absorber K | — | 1.34 | — | 1.38 |
| Additive L | — | 0.09 | — | 0.09 |
| Additive M | — | 0.20 | — | 0.21 |
| Additive N | — | 7.09 | — | 7.29 |
| Catalyst P | — | 0.09 | — | 0.09 |
| Additive Q | — | 1.19 | — | 1.22 |
| Pigment X | 1.40 | 2.68 | — | — |
| Total | 100.00 | 100.00 | 100.00 | 100.00 |

Resin A is a siliconized polyester resin having a weight average molecular mass, M_{w}, of 33,000 g/mol, a hydroxyl number of 50 mg KOH/g, and an acid value of 8.0 mg KOH/g.

Cross-linking agent B is hexamethoxymethyl melamine.

Solvent C is diethylene glycol monobutyl ether acetate.

Base D is a combination of polyester resins, colored pigments, a hydrocarbon fluid commercially available under the name Aromatic 100, solvents, and hexamethoxymethyl melamine.

Varnish E is a fluoropolymer varnish comprising a fluoropolymer resin, aromatic hydrocarbons, trimethyl benzene, naphthalene, cyclohexanone, xylene, and ethylbenzene.

Additive F is an organically modified bentonite clay thickener comprising tetraalkyl ammonium bentonite.

Solvent G is n-butanol.

Isocyanate H is an aliphatic blocked polyisocyanate based on hexamethylene diisocyanate.

Additive J is a combination of a methylated melamine-formaldehyde resin and butylated melamine in n-butanol.

UV Absorber K is combination comprising a liquid hydroxyphenyl-triazine ultraviolet light absorber comprising a mixture of 2-[4-[(2-hydroxy-3-dodecyloxypropyl)oxy]-2-hydroxyphenyl]-4,6-bis)2,4-dimethylphenyl)-1,3,5-triazine and 2-[4-[(2-hydroxy-3-tridecyloxypropyl)oxy]-2-hydroxyphenyl]-4,6-bis)2,4-dimethylphenyl)-1,3,5-triazine.

Additive L is diisopropanolamine.

Additive M is a combination of a solution of a polyether modified methylalkylpolysiloxane copolymer in butoxyethanol and a solution of a polyester modified dimethylpolysiloxane in xylene.

Additive N is a hydrocarbon fluid commercially available under the name Aromatic 150.

Catalyst P is dinonylnaphthalene sulfonic acid.

Additive Q is silica gel.

Pigment X is an interference pigment that has a transmission of electromagnetic radiation in the wavelength from 400 nm to 700 nm and at least 40% of electromagnetic radiation in the wavelength from 780 nm to 2,500 nm. Pigment X is a translucent multi-layer pigment with a highest transmission value for wavelengths of photosynthetic active light. Pigment X has a positive light red/dark red ratio of 1.4:1.

The coating compositions of Examples 1-2 and reference coating compositions of Reference Examples 3-4 are then applied to separate steel substrates by a roll-coating process at a film thickness of about 0.7 mil. The coating compositions are cured on the metal substrate in an oven at a peak metal temperature (PMT) of 450° F. to form the cured films of Examples 1A-2A and Reference Examples 3A-4A. The cured films of each Example and Reference Example are measured for solar reflectance and emissivity in accordance with ASTM E903-96 and ASTM C1549-04. The solar reflectance index is determined for each Example and Reference Example in accordance with ASTM E1980-01. The specific values for solar reflectance of Ex. 1A and Ref Ex. 3A are indicated in Table 2.

TABLE 2

| | Ex. 1A | Ref. Ex. 3A |
|---|---|---|
| Solar reflectance | 37.8 | 25.8 |

The cured film of Example 1A formed from the coating composition of Example 1 has a solar reflectance of greater than 0.75 in the wavelength of from 250 nm to 2,500 nm as measured in accordance with ASTM E903-96 and ASTM C1549-04.

In contrast, the cured film of Reference Example 3A formed from the reference coating composition of Reference Example 3 has a solar reflectance of less than 0.75 in the wavelength of from 250 nm to 2,500 nm as measured in accordance with ASTM E903-96 and ASTM C1549-04.

As is clear when comparing the solar reflectance of Example 1A and Reference Example 3A, the method of the present invention advantageously achieves “cool roof” performance for the cured film of Example 1A. In particular, the method provides the cured film of Example 1A having excellent solar reflectance. Finally, since each additional percentage point of solar reflectance reduces metal substrate temperature by one degree, the method of the present invention also optimizes energy consumption and costs. In particular, the method enables energy cost savings, since interior spaces of buildings and vehicles are kept cool, optimizes roof life expectancy based on minimized roof expansion and contraction, and allows potential qualification for monetary incentives that are offered for cured films 14 having excellent solar reflectance.

Notably, the cured film of Example 1A is statutorily compliant for solar reflectance under California Title 24 Building Energy Efficiency Standard (effective October 2005) the Leadership in Energy and Environmental Design (LEED) version 2.2 guidelines (effective January 2006).

As evidenced by the cured film of Examples 1A, the method of maintaining the color of the cured film formed from the coating composition comprising Pigment X optimizes the solar reflectance of the cured films for colors such as the colors of the cured films of Reference Example 3A. More specifically, the method optimizes the solar reflectance of the cured film of Examples 1A while maintaining the color of the cured films.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described within the scope of the appended claims.

What is claimed is:

1. A method of maintaining a color of a cured film formed from a coating composition on a metal substrate relative to a standard, said method comprising the steps of:
providing a resin;
providing a pigment;
combining the pigment and the resin to form the coating composition;
applying the coating composition to the metal substrate;
curing the coating composition on the metal substrate to form the cured film having a color defined by an L value, an a value, and a b value as measured by a spectrophotometer according to a Hunter L, a, b color scale; and
maintaining the color of the cured film relative to the standard having an Lₛ value, an aₛ value, and a bₛ value whereby the L value, the a value, and the b value of the cured film each change less than 20% respectively as compared to the Lₛ value, the aₛ value, and the bₛ value of the standard;
wherein the cured film formed from the coating composition has a solar reflectance of greater than or equal to 0.75 in the wavelength from 250 nm to 2,500 nm as measured in accordance with ASTM E903-96 and ASTM C1549-04.

2. The method as set forth in claim 1 wherein the pigment comprises a mica particle and a coating disposed on the mica particle.

3. The method as set forth in claim 2 wherein the coating comprises at least two layers.

4. The method as set forth in claim 3 wherein the coating comprises titanium dioxide, silicon dioxide, tin oxide, and zirconium oxide.

5. The method as set forth in claim 2 wherein the pigment has a transmission of at least 50% of electromagnetic radiation in the wavelength from 400 nm to 700 nm and at least 40% of electromagnetic radiation in the wavelength from 780 nm to 2,500 nm.

6. The method as set forth in claim 2 wherein the pigment is translucent.

7. The method as set forth in claim 1 wherein the pigment has a particle size of from about 10 to 60 μm as measured in accordance with ISO 1524.

8. The method as set forth in claim 1 wherein the pigment is present in the coating composition in an amount of from 0.25 to 5 parts by weight based on 100 parts by weight of the coating composition.

9. The method as set forth in claim 1 wherein said step of maintaining is further defined as maintaining the color of the cured film relative to the standard such that the L value, the a value, and the b value of the cured film each change less than 15% respectively as compared to the Lₛ value, the aₛ value, and the bₛ value of the standard.

10. The method as set forth in claim 1 wherein the cured film formed from the coating composition has an emissivity of greater than or equal to 0.75 in the wavelength from 250 nm to 2,500 nm as measured in accordance with ASTM E408-71 and ASTM C1371-04a.

11. The method as set forth in claim 10 wherein the cured film formed from the coating composition has a solar reflectance index of greater than 78 as determined in accordance with ASTM E1980-01.

12. The method as set forth in claim 1 wherein the cured film formed from the coating composition has a solar reflectance index of greater than 78 as determined in accordance with ASTM E1980-01.

13. The method as set forth in claim 1 wherein the resin is further defined as a siliconized polyester resin.

14. The method as set forth in claim 1 wherein the resin is further defined as a polyvinylidine difluoride resin.

15. The method as set forth in claim 1 wherein said step of applying the coating composition is further defined as providing at least one roller and transferring the coating composition from the at least one roller to the metal substrate.

16. The method as set forth in claim 15 wherein said step of curing the coating composition is conducted at a temperature of from 700° F. to 900° F. for a period of from 20 to 100 seconds.

17. The method as set forth in claim 1 wherein said step of applying the coating composition is further defined as spraying the coating composition onto the metal substrate.

18. The method as set forth in claim 1 further comprising the step of cooling the cured film formed from the coating composition to about an ambient temperature.

19. The method as set forth in claim 1 wherein the color of the cured film is defined by an L value of less than or equal to 75, a negative a value, and a negative b value as measured by a spectrophotometer according to the Hunter L, a, b color scale.

20. A coating system comprising:
a metal substrate; and
a cured film having a color disposed on said metal substrate, said cured film formed from a coating composition comprising a pigment for maintaining said color of said cured film relative to a standard;
wherein said color of said cured film is defined by an L value, an a value, and a b value as measured by a spectrophotometer according to a Hunter L, a, b color scale; and
wherein said standard has an Lₛ value, an aₛ value, and a bₛ value; and
wherein said color of said cured film is maintained relative to said standard such that said L value, said a value, and said b value of said cured film each change less than 20% respectively as compared to said Lₛ value, said aₛ value, and said bₛ value of said standard so that said cured film has a solar reflectance of greater than 0.75 in the wavelength from 250 nm to 2,500 nm as measured in accordance with ASTM E903-96 and ASTM C1549-04.

21. A coating system as set forth in claim 20 wherein said cured film has an emissivity of greater than or equal to 0.75 in the wavelength from 250 nm to 2,500 nm as measured in accordance with ASTM E408-71 and ASTM C1371-04a.

22. A coating system as set forth in claim 21 wherein said cured film has a solar reflectance index of greater than 78 as determined in accordance with ASTM E1980-01.

23. A coating system as set forth in claim 20 wherein said cured film has a solar reflectance index of greater than 78 as determined in accordance with ASTM E1980-01.

24. A coating system as set forth in claim 20 wherein said pigment comprises a mica particle and a coating disposed on said mica particle comprising at least one inorganic oxide.

25. A coating system as set forth in claim 24 wherein said pigment has a transmission of at least 50% of electromagnetic radiation in the wavelength from 400 nm to 700 nm and at least 40% of electromagnetic radiation in the wavelength from 780 nm to 2,500 nm.

26. A coating system as set forth in claim 20 wherein said color of said cured film is maintained relative to said standard such that said L value, said a value, and said b value of said cured film each change less than 15% respectively as compared to said Lₛ value, said aₛ value, and said bₛ value of said standard.

27. A coating system as set forth in claim 20 wherein said color of said cured film is defined by an L value of less than or equal to 75, a negative a value, and a negative b value as measured by a spectrophotometer according to the Hunter L, a, b color scale.

28. A coating system as set forth in claim 20 wherein said metal substrate is further defined as a roof of a building.
